(19) United States
(12) Patent Application Publication
(10) Pub. No.: US 2008/0026357 A1
(43) Pub. Date: Jan. 31, 2008

(54) Discipline oriented contextual learning software system

(75) Inventors: Gilbert Baumslag, New York, NY (US); Benjamin Fine, Stamford, CT (US); Charles F. Miller, North Balwyn (AU); Yegor Bryukhov, Ridgefield Park, NJ (US)

Correspondence Address: DARBY & DARBY P.C., P.O. BOX 770, Church Street Station, New York, NY, 10008-0770, US

(73) Assignee: Research Foundation of the City University of New York, New York, NY (US)

(21) Appl. No.: 11/487,154

(22) Filed: Jul. 14, 2006

(51) Int. Cl. G09B 3/00

(52) U.S. Cl. 434/322

(57) ABSTRACT

A method for contextual computer-based instruction concerning a discipline. Information-units that are relevant to the discipline are stored in a computer that includes interactive user-interface software. The user-interface software accepts at least one input data set having a data-type. Data sets are rendered as iconic representations with which the user interacts and can select one or more representations. In response to the selection of one or more iconic representations, the software establishes a selectable list of user-operations available through the software and further enables one of the information units for user-selection through the software on the basis of the currently selected iconic representation. The particular information unit enabled can provide contextually-sensitive information regarding the selected iconic representation. The software can further generate additional iconic representations that are associated with a user-selected iconic representation based on any user-selected operation performed on the user-selected data set.

### FIELD OF THE INVENTION

The present invention relates to a method and system for contextual learning software in a specified discipline, and more particularly, is directed to a method and system for providing instruction in a particular discipline through contextual exploration and discussion of user controlled data and inputs.

### BACKGROUND OF THE INVENTION

Software is being employed as a teaching tool and a practical tool in many varied disciplines. Frequently, practical software is employed as a teaching assistance tool for a particular discipline. However, existing practical software does not directly facilitate the teaching of a discipline. Conversely, existing teaching tools do not facilitate the practice of a particular discipline.

Typical existing software education programs provide directed lessons. The student/user interacts with the software and proceeds through the stages of the lesson, typically by using predefined, or “canned,” exercises. The user is typically not permitted to enter customized scenarios and explore real world datasets in which the student is presently interested. At most, the educational software permits a very limited degree of interaction and customization.

In contrast practical software, such as spreadsheet programs commercially available from Microsoft (Excel) and others, typically assume a pre-acquired level of knowledge or expertise in the discipline to which the software is directed. Any help that is provided by the software concerns how to operate the software and interact with the software to achieve the desired results. However, such practical application software does not provide help on understanding or learning the underlying discipline itself. If a user is not familiar with a specific task or operation, then the user will need to seek instruction on that task or operation outside of the context of the practical software.

What is needed in the art is a system that combines the applicability and problem solving abilities of practical software with the instructional aspects of teaching software.

### SUMMARY OF THE INVENTION

In accordance with one aspect of the present invention, a method for computer-based instruction concerning a discipline is provided. The computer preferably includes a processor, a storage device, a user input device, and a display. Additionally, a plurality of information-units that are relevant to the discipline are stored in the storage device, and the computer further includes interactive user-interface software executing on the processor. The user-interface software is programmed to accept at least one input data set having a data-type, through the user-interface software at the user's direction. Data sets are rendered as iconic representation on the display of the computer. The user can interact with the computer and select one or more of the iconic representations using the user input device. In response to the selection of any one or more iconic representations, the software dynamically establishes a selectable list of user-operations available through the user-interface software and further enables a particular one of the information units for user-selection through the user-interface software on the basis of a currently selected iconic representation. The particular information unit enabled can provide contextually-sensitive information regarding the currently selected iconic representation.

In accordance with further aspects of the present invention, before enabling a particular information unit, the user-interface software can further generate additional iconic representations. The additional iconic representations are associated with a user-selected iconic representation based on any user-selected operation to be performed on the selected data set.

In accordance with a further aspect of the present invention, a system for computer-based instruction concerning a discipline is provided. The system typically includes a computer having a processor, a storage device, a display, and a user input device that is interactively coupled with the computer. Information-units that are relevant to the discipline are stored in the computer storage device. The system executes, on the processor of the computer, an interactive user interface software. The user-interface software is programmed to accept at user direction at least one input data set having a data-type. Data sets are rendered as iconic representations on the display. The software further enables a user to select one or more of the iconic representations using the user input device. In response to any selection of the one or more iconic representations, the user-interface software dynamically establishes a selectable list of user-operations. On the basis of a currently selected iconic representation, the software further enables a particular information unit that provides contextually-sensitive information regarding the currently selected iconic representation.

Other aspects and features of the present invention can be appreciate from the accompanying description of certain embodiments and associated drawing figures.

### BRIEF DESCRIPTION OF THE DRAWINGS

FIG. 1 depicts an exemplary user interface in accordance with an embodiment of the present invention;

FIG. 2 depicts a further exemplary user interface displaying data import menu options;

FIG. 3 depicts a third exemplary user interface displaying data import screen and explanation;

FIG. 4 depicts a fourth exemplary user interface displaying contextually relevant user-operations for a multi-variable data set;

FIG. 5 depicts a fifth exemplary user interface displaying contextually relevant user-operations for a two-variable data set;

FIG. 6 depicts a sixth exemplary user interface displaying multiple data sets, derived data sets therefrom, and a further data set check-in screen;

FIG. 7 depicts a seventh exemplary user interface displaying contextually relevant information of a derived data set and more detailed discipline oriented explanation thereof;

FIG. 8 depicts an eight exemplary user interface displaying contextually relevant information of a further derived data set and more detailed discipline oriented explanation thereof; and

FIG. 9 is a flow diagram, illustrating operation of a software system in accordance with the invention.

### DETAILED DESCRIPTION OF CERTAIN EMBODIMENTS

By way of overview and introduction, the present invention provides a method and system for computer-based instruction software directed to a particular discipline. The software is programmed to accept data sets in various formats and types that are relevant to the particular discipline. The software renders the data sets in an iconic representation, which are selectable by a user through a user-input device interactively connected to the computer. When the user selects one or more of the iconic data representations, the software presents the user with a list of discipline-oriented operations available for execution given the particular user selection. In this manner, only those operations which are contextually relevant to the selected data are presented to the user.

Additionally, the selection of one of the iconic representations enables a user to explore the discipline-oriented meaning or significance of the selected icon by further selecting a particular information unit made available for selection by the software. The particular information unit that is made available is contextually relevant to the data and/or operation of the selected icon at that point in the program flow. The information units are not generally directed to the explanation of the operation of the software, but instead are directed toward the understanding and explanation of the data and/or operation within the discipline to which the software is directed. The information units enabled and displayed can include varying levels of detail and allow a user to drill-down into further detail about the discipline.

By providing multiple levels of detail and easy execution of relevant discipline-oriented operations in connection with iconic representations of data, a software system and method in accordance with this invention is directed to a broad audience. The invention can enable users with practically no understanding or experience in a particular discipline to rapidly perform various sophisticated operations and obtain multiple levels of instruction regarding the discipline. Additionally, users who are moderately familiar with the discipline, as well as more advanced users, can benefit from the simplicity of performing sophisticated discipline-oriented operations over iconic representations of data and can further enhance their understanding of the discipline through the contextually-sensitive information directed to explanation of the operations and data within the discipline.

While this invention is applicable to any discipline, it is most easily understood by way of example of a specific discipline. Thus, the following discussion describes the invention as implemented in computer based instructional software for statistics. However, it is to be understood that the same techniques are readily adapted to multiple disciplines. A short discussion of other disciplinary implementations follows the statistics-oriented example.

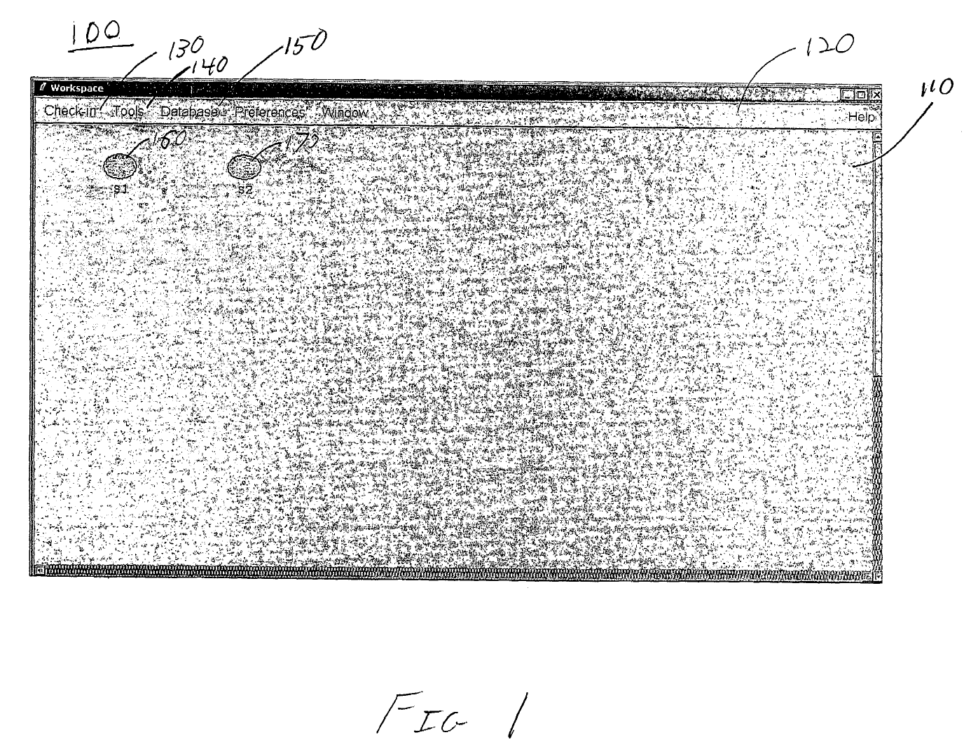

FIG. 1 illustrates one embodiment of the computer based instruction software. The software display 100 includes a workspace 110 and a menu-bar 120. The workspace 110 includes iconic representations of data and transformations of data within the workspace 100. Specifically, in this example, the workspace 110 includes a one variable data set S1 160 and a two variable data set S2 170. A user can interact with a user-pointer device and the data sets displayed in the workspace 110 and the menu-bar 120 to explore the discipline of the instructional software.

Menu-bar 120 can include various dropdown menus including Check-in 130, Tools 140, Database 150, and other commonly implemented software options (e.g., Preferences and Window). The Check-in menu 130 can enable a user to direct the software to accept additional data sets. When a data set is selected, the Tools menu 140 displays the available operations for that data set. As described below, the particular entries in the Tools Menu 140 are dynamically adjusted as a function of the user-selected iconic representation in the workspace 110. Database menu 150 enables a user to load or save a workspace so that a user can work and explore the same data sets and results over multiple invocations of the instructional software.

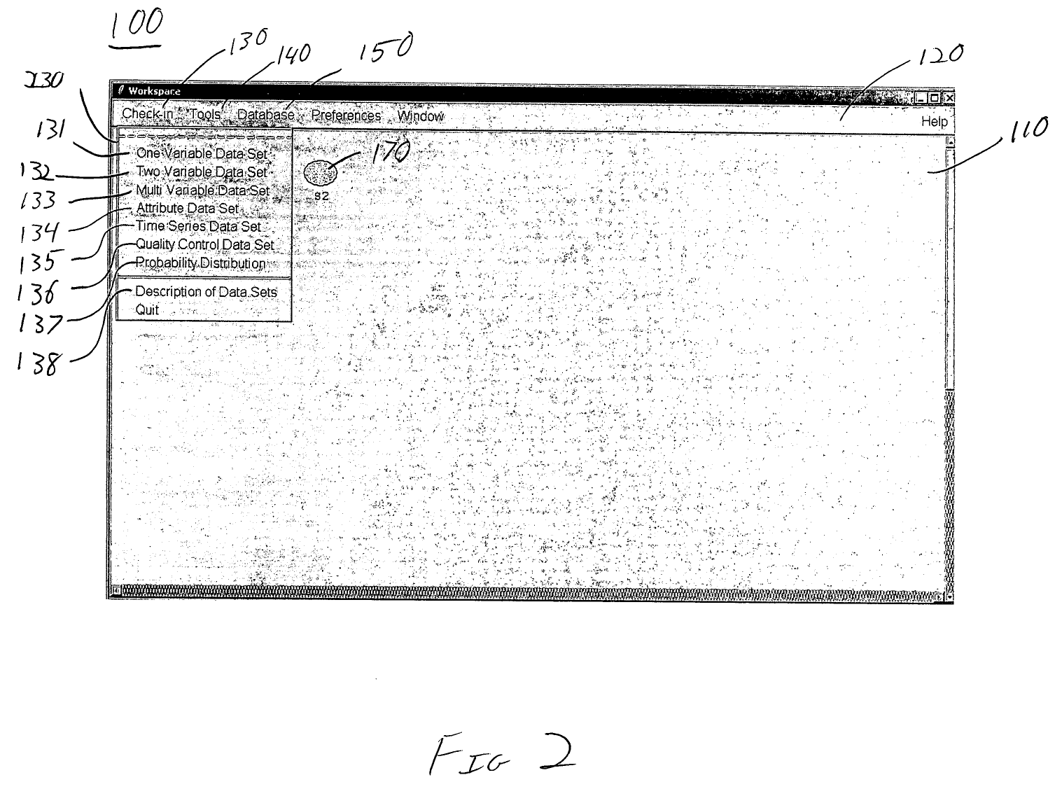

A user can add data sets to the workspace 110 by checking-in additional data sets using the check-in drop down menu. In one embodiment, illustrated in FIG. 2, selection of Check-in 130 displays menu 230. Menu 230 can present the user with the operations to enable the check-in of recognized data-types. For example, FIG. 2 illustrates the option to check-in a one variable data set 231, two variable data set 232, multi-variable data set 233, attribute data set 234, time series data set 235, quality control data set 236, and a probability distribution data set 237.

Alternatively, a user can check-in data from an external application or file such as a database, spreadsheet, flat-file, or other commonly used data storage mechanism. In such an implementation, the user can manually identify the data type of the data set being checked in. Alternatively, the instructional software can analyze the data being checked-in to determine the appropriate data-type. Analysis can include an examination of the structure of the data as well as parsing the data to determine best fit against known patterns (e.g., date/time). Such analysis applies a rule-base against the incoming data in order to determine the data type.

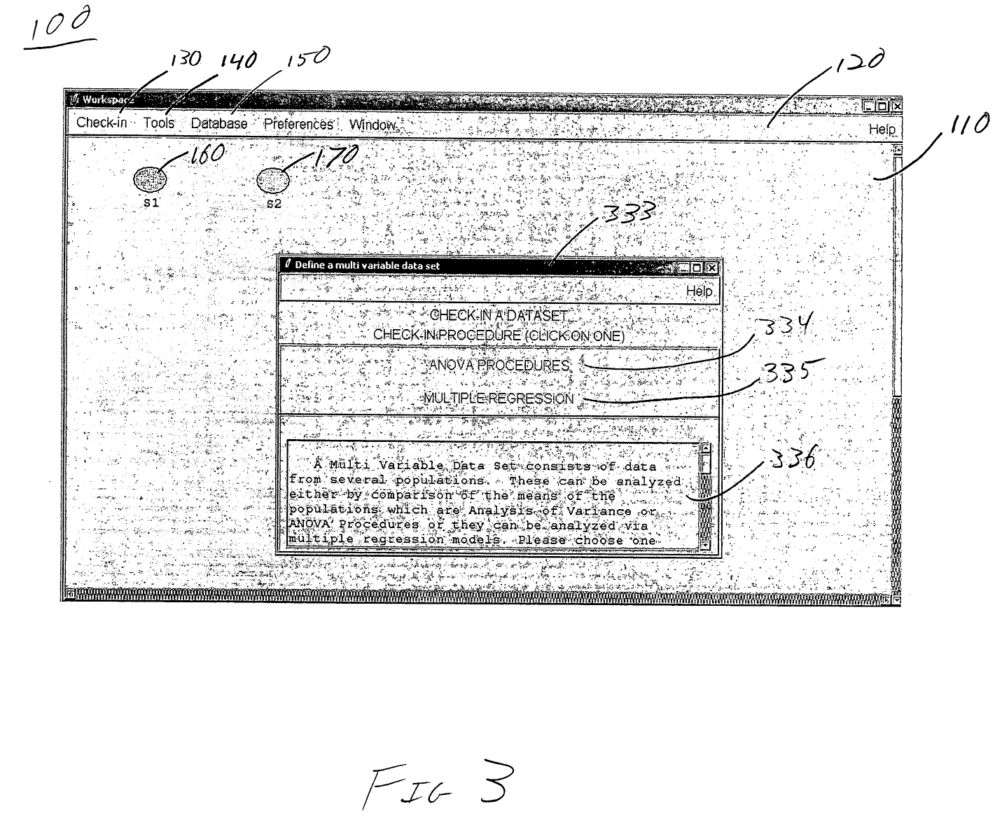

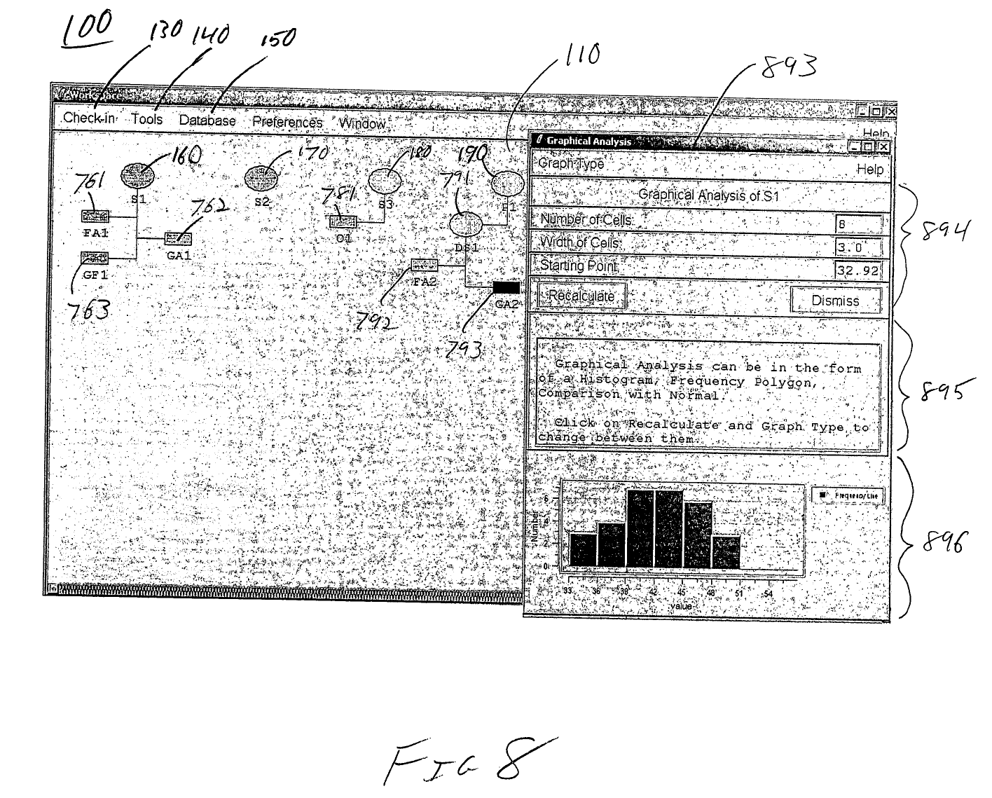

If the user selects a check-in of multi-variable data 233, the user is further presented with a “multi-variable” data set check-in dialog 333, as illustrated by way of example as a dialog box in FIG. 3. The dialog 333 presents the user with the different types of multi-variable data, including Analysis of Variance between groups (ANOVA), Procedures 334, and multiple regression 335. Furthermore, the dialog 333 can display a discipline oriented explanation of options being presented 336. For example, the explanation can be of the software information unit relevant to properties and operations available for a “multi-variable” data set. Once the user checks-in the multi-variable data, an iconic representation of the data set S3 190 (FIG. 8) is rendered on the workspace 110.

The user can interact with the iconic representations (e.g., multi-variable data set S3 190) using a user-pointer device. Furthermore, a particular one or more iconic representation can be selected by the user through the software using the input device. In response to any selection of one or more iconic representations, the instructional software dynamically establishes a selectable list of user-operations that are contextually relevant to the iconic selection. By selecting a user-operation, the user directs the computer and software system to execute the specified operation. While performance of the operation is carried out by the computer, a specific user-operation can request additional input from the user to specify selected parameters.

User-operations can include tools, tests, and transformations. The list can be created from a rule base, for example in table or database form, associating data-types with relevant operations. Alternatively, in an object oriented environment, each data-type can be associated with a specific object-type which identifies the operations, access, and analysis available for that that particular object-type. Additionally, a similar mechanism can be used to generate the list of user-operations available upon the selection of multiple data sets. For example, a multi-dimensional rule-based table, or object methods accepting one or more data-types as inputs, can define the operations available for a given selection of data-types.

Additional user-operations and data-types can be added to the software to suit a particular academic course or expand the existing discipline-oriented functionality. These user-operations and/or data-types can be provided as libraries or software packages that can be loaded into the system. By extending the functionality of the software, a user can progress to a more advanced or alternative academic course. Additionally, a less experienced user can avoid being overwhelmed by unfamiliar operations and data-types, but as the user becomes ready to progress within the discipline, additional functionality can be incorporated into the system

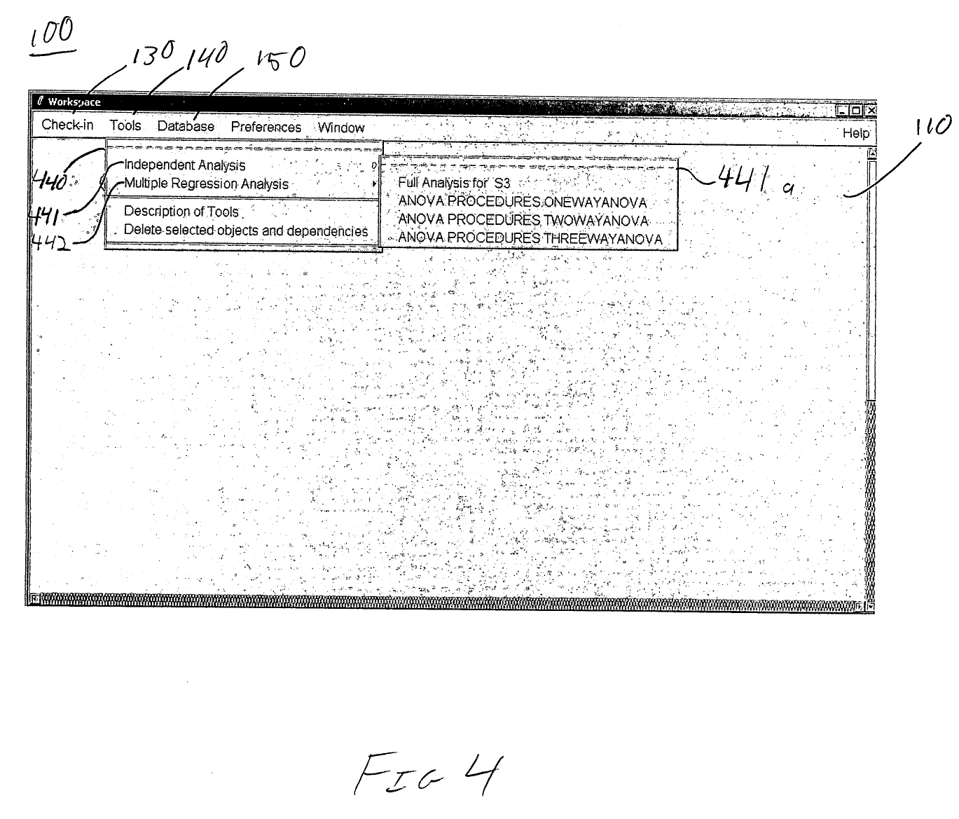

FIG. 4 illustrates the dynamically established list of multi-variable user-operations 440 for multi-variable data set S3 190 that is displayed after the user selects data set S3 and dropdown menu Tools 140. For example, the contextually relevant operations that are enabled upon selection of data set S3 190 includes the categories of independent analysis 441 and multiple regression analysis 442. Independent analysis 441 presents the further operations in menu 441A, which include full analysis and various ANOVA procedures.

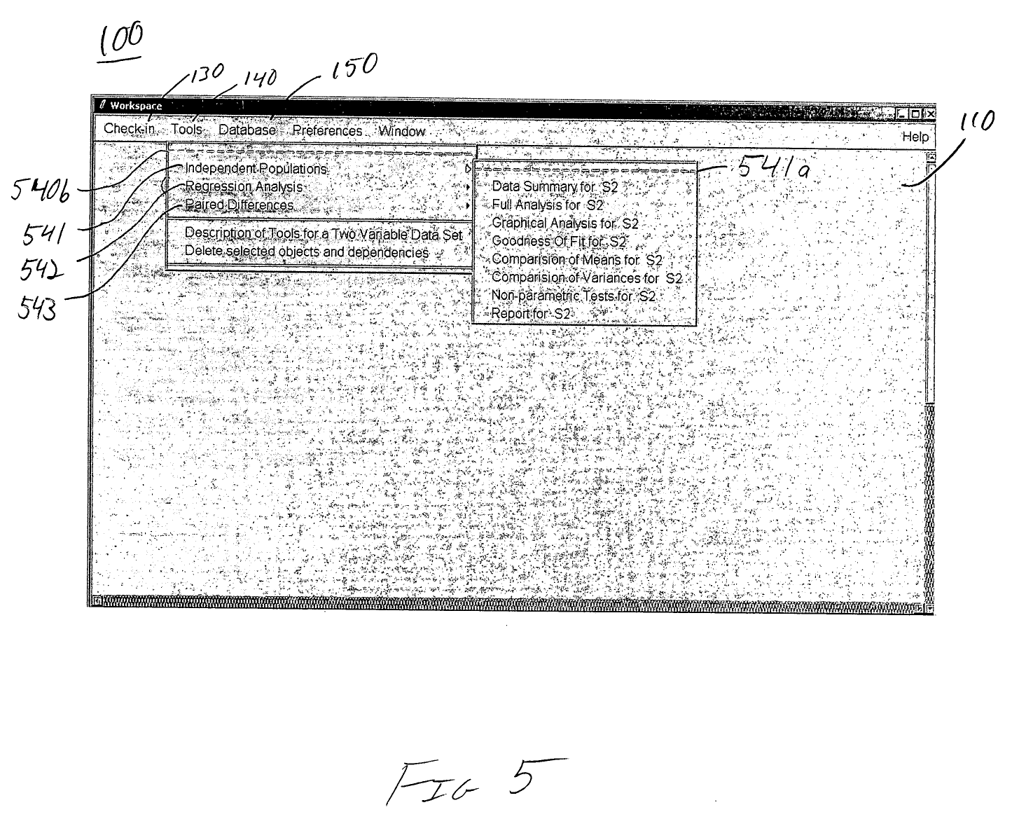

By comparison, FIG. 5 illustrates the dynamically established list of multivariable user-operations 540 for a two variable data set S2 180 that is displayed after the user selected data set S2 180 and dropdown menu Tools 140. The two variable operations menu 540 includes operations that were not available in the multivariable menu 440, and vice-versa, because the operations are only contextually relevant to the either two-variable data or multi-variable data. For example, Paired Differences 543 is not available in multi-variable tools menu 440, but is available in the two-variable operations menu 540. However, a regression analysis can be performed over both multi-variable and two variable data, thus, the regression analysis operation is enabled in two-variable regression analysis 542 and multi-variable regression analysis 442. Each entry in the dropdown menu can be a category or specific item. For example, category Independent Populations 541 provides further sub-operations in menu 541A.

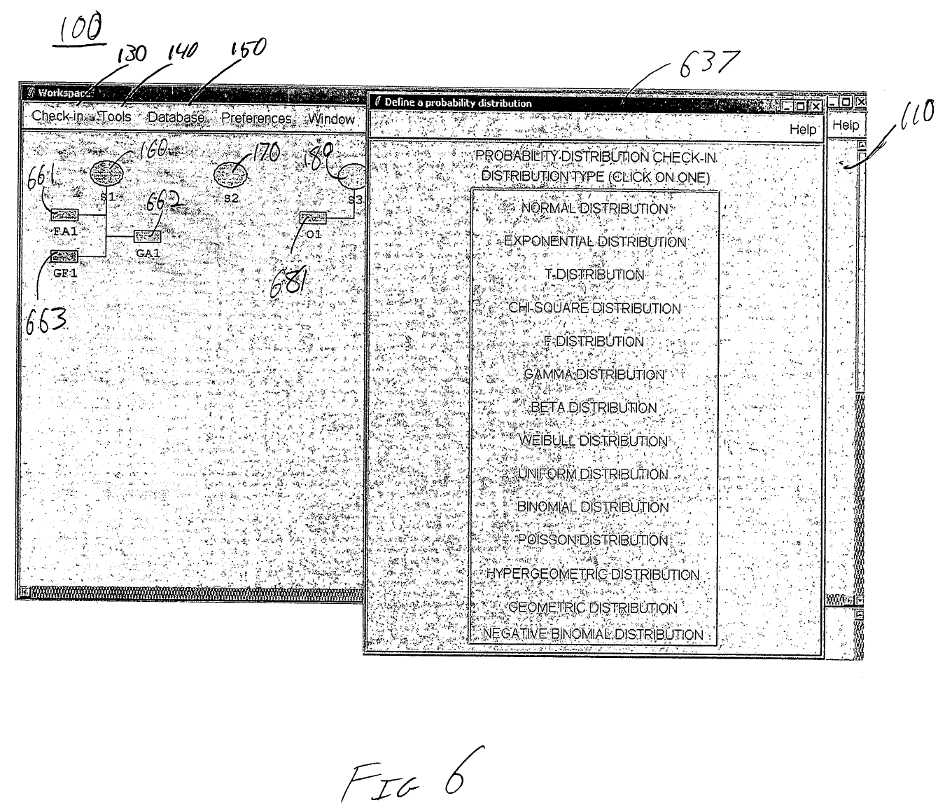

Selection of a particular user-operation can generate one or more additional iconic representations from the result or transformation that is performed by the software. FIG. 6 illustrates the workspace 110 after several user-operations have been performed. For example, after selecting data set S1 160, the user in this example selected a full analysis of the data set from user-operation menu 441a, producing iconic the additional iconic representation FA1 661. Additionally, user-operations from menu 441a were further selected to produce the additional iconic representations for graphical analysis GA1 662 and a goodness fit GF1 663. Similarly, after selecting multivariable data set S3, a one-way ANOVA procedure user-operation from menu 441A was performed resulting in the additional iconic representation O1 181.

The workspace 110 in FIG. 6 enables a user to easily distinguish between data sets and derived or transformed data. Each iconic representation that is not a user-input data set, including full analysis FA1 661, graphical analysis 662, goodness fit GF1 663 and one-way ANOVA procedure O1 681, are preferably represented as in a visually distinct manner from the user-input data sets presented in the workspace 110. The embodiment in FIG. 6 displays user-input data sets as oval and iconic representations produced by user-operations as rectangles. The software can further visually distinguish the significance of iconic representation through the use of other geometric shapes, colors, symbols, or textual indicators. Preferably, the icon selection includes the consideration of the data-type of a data set, or whether the icon represents a data set or a result of a user-operation.

In a further feature of the present invention, the user-operation generated iconic representations can be presented in a manner that enables the user to quickly discern their relationship to the corresponding data set on which the user-operation was executed. FIG. 6 illustrates the relationship between full analysis FA1 661 and data set S1 by the line connecting FA1 661 to S1 160. Similarly, one-way ANOVA procedure results O1 681 is connected to multi-variable data set S3 180 so as to illustrate that O1 681 is a result of a user-operation performed on S3 180.

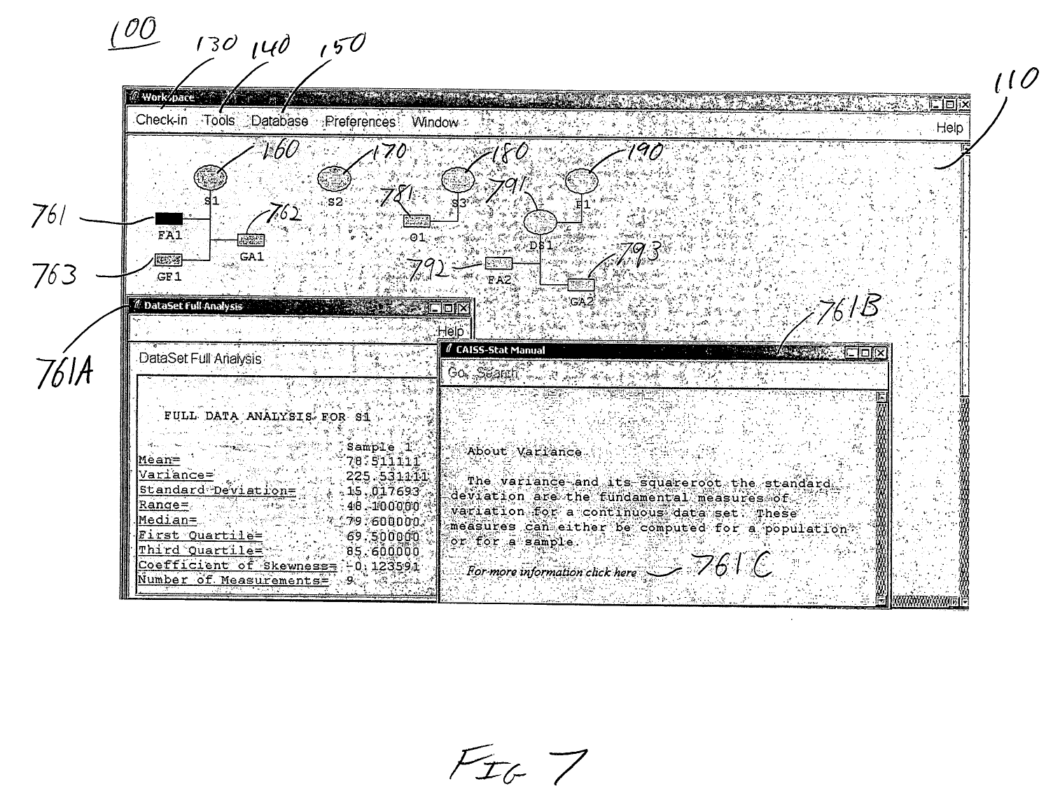

The graphical indication of relationships between data sets and user-operation results can be expanded to a full tree-like structure as illustrated in FIG. 7. Data set P1 190 is illustrated as related do data set DS1 791, and full analysis FA2 792 is related to data set DS1 691. Where appropriate, an iconic representation of the results of a user-operation can include branches to additional iconic representations of further analysis that is performed on the results of user-operations.

In a further detail of a particular embodiment of the present invention, data sets are not limited to quantitative data and samples. For example, as applied the statistics learning software, FIG. 6 illustrates the ability to check-in a data set that is a probability distribution through menu 637. For example, the user can create a data set that includes the equations modeling a normal distribution having a specified mean and a specified standard deviation, as illustrated by data set P1 190 in FIG. 7. Furthermore, a user can simulate a data sample based on the probability data, as illustrated by data-sample DS1 791.

The creation of “ideal” samples, such as probability distributions, can be widely adapted to various disciplines. Such an ideal data set can be created and used as a form of benchmark or model data set in any discipline. For example, a data population can be created to represent any equation or a set of discrete indicators relevant to the specified discipline. These “ideal” data sets, or benchmark datasets, can be used as a point of comparison for other data. Parallel user-operations can be executed over the “ideal” dataset and compared with the result of the same user-operation executed over a user-input data set. Thus, experimental data can be easily compared with its theoretical counterpart that is governed by an equation.

With reference to the exploration of the data and the discipline, selecting any one of the iconic representations enables at least one contextually-relevant information unit for display. FIG. 7 illustrates a selection of FA1 761. The software visually indicates that FA1 761 is selected by visually distinguishing it from the other iconic representations in workspace 110.

Selecting FA1 761 enables an information unit explaining and identifying the meaning of the user-operation that generates FA1 761 in window 761A. As illustrated in window 761A, a full analysis of data set S1 160 includes the mean, variance, standard deviation, range, median, first quartile, third quartile, coefficient of skewness, and the number of measurements. To further explore the meaning of this analysis, each item in the analysis is selectable to display a further explanatory window 761B that provides greater detail on the selected discipline-oriented meaning of the item. For example window 761B illustrates a further explanation of the meaning of “variance.”

Multiple levels of discipline-related explanation and cross-referenced explanatory information can be provided by the software by linking from one information unit to another. For example window 761B, includes link 761C which provides additional, more comprehensive details, regarding statistical variance. Further detail can be provided on specific words or phrases within the text of the explanation in window 761B (e.g., standard deviation, population, sample, etc . . . ). The cross-referenced or linked information can be provided through a standard means of linking textual or graphical information such as hyper-links using HTML or standard help file formats.

In addition to the discipline oriented explanation of the data in the derived data sets (i.e., the results of a user-operation on a data set) illustrated in windows 761A and 761B, the discipline oriented explanation can further describe the relationship between the derived data set and the data set to which the user-operation was applied. This discipline oriented explanation can be enabled by selection of the derived data set or by selection of the visual link indicating the relationship between the two icons.

In a further feature of the present invention, the discipline oriented explanation of the user-operation derived data set can incorporate into the explanation the data of the selected data set. This feature provides a more concrete discussion and example of the principle being explained by the information unit. Rather than discussing the discipline in abstract terms and symbols, or using examples with which the student may not be familiar, the software can present the discipline-oriented explanation utilizing the very data with which the user is familiar.

FIG. 8 is a further illustration of one technique of demonstrating and explaining the particular discipline (i.e., statistics) utilizing the data input by the user. The selection of graphical analysis GA2 793 can result in the display of window 893. Window 893 includes a customization portion 894, an explanation portion 895, and a results portion 896. Customization portion 894 enables the user to customize the parameters used by the software in performing the graphical analysis operation. The bar graph example presented in window 893 includes the number of cells, width of cells, and starting point of the graph displayed in results portion 896. However, customization parameters are not limited to those illustrated and can be expanded to include levels of confidence, standard deviations, probabilities, ranges, and other coefficients.

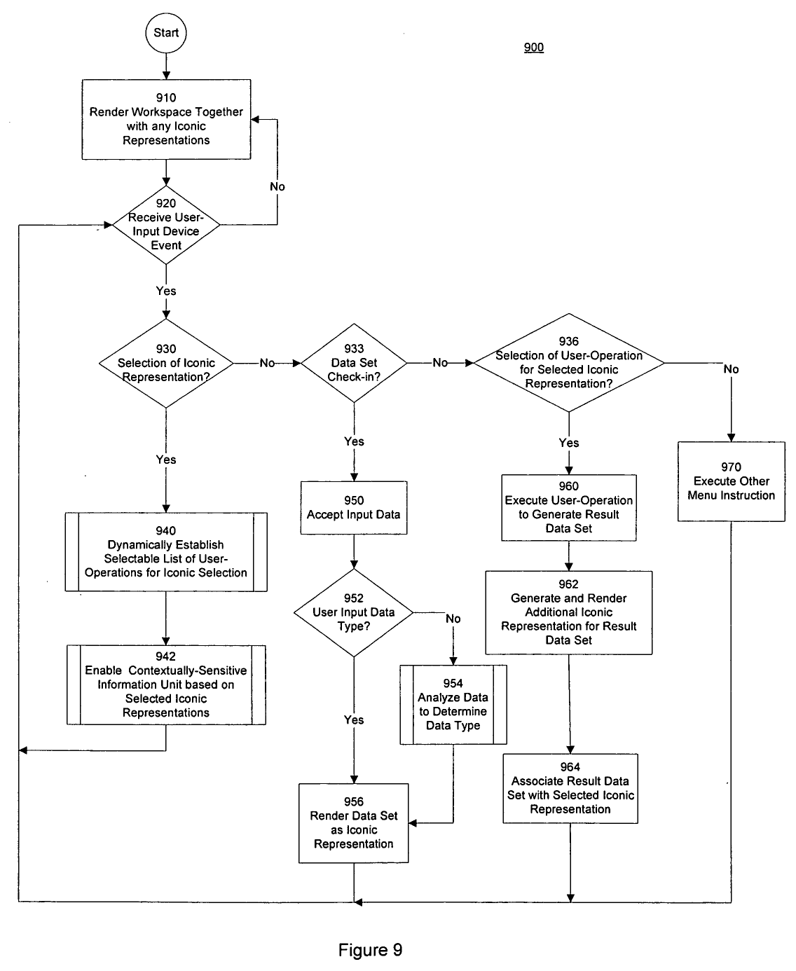

Thus, FIGS. 1-8, and the accompanying discussion, illustrate certain embodiments of a software system implementing the present invention. The embodiment discussed with respect to those figures implement a method in accordance with the present invention. FIG. 9 is a flow diagram illustrating an example process flow 900 of a method in accordance with the present invention.

The process 900 begins at step 910 at which the workspace 110 and previously generated iconic representations are rendered on the display of the computer, as illustrated in FIG. 1. The system checks for an event from the user-input device at 920. If no event is received, the system returns to 910 and continues to render the workspace 110. However, if a user-input device event is received, process 900 proceeds to analyze the event to determine the appropriate actions to be taken.

The process 900 determines if the user-input device event is a selection of one or more iconic representations at step 930. If the event is a selection of an iconic representation, the system, at step 940, dynamically establishes a selectable list of user-operations for iconic the particular iconic selection. The list of user-operations includes those operations that are contextually relevant to the selection of iconic representations. An example of the list of user-operations for multi-variable data set S3 180 is illustrated in dropdown menu 440 of FIG. 4. At step 942, the system further enables a particular contextually-sensitive information unit based on the selected iconic representation. The process 900 then proceeds to step 920 to await further user-input device events.

If the user-input device event at step 920 is not a selection of an iconic representation, the process 900 implemented by the system determines whether the user-input device even is a check-in of additional data at step 933. The system then prompts for and accepts an input data set at 950, and as illustrated in FIG. 3 by check-in window 333. Optionally, the system can check whether the user has specified a data-type to be associated with the input data at 952. If the data-type was specified by the user, the data set is rendered at step 956 as an additional iconic representation in the workspace 110. If no data-type was specified, process 900 first analyzes the input data to perform an automated determination of the data-type at 954, and then renders the data set as an iconic representation at step 956. The process 900 then proceeds to step 910 to render the workspace 110 and await further user-input device events.

At step 936, the system determines if the user-input device event is a selection of a user-operation from the list of user-operations established for a selected iconic representation at step 940. If the event is a selection of a user-operation, the process 900 executes the user-operation at 960 to generate a result dataset. At step 962, the result data set is then rendered as an additional iconic representation that is associated with the selected iconic representation. FIG. 6 illustrates the workspace 110 after several data sets have been checked-in by the user, and multiple user-operations have been selected and executed over the user-input data sets to generate additional iconic representations. The process 900 then proceeds to step 910 to render the workspace 110 and await further user-input device events.

If one of the preceding decisions has not handled the user-input device event, it is a further menu selection as known in the art. Process 900 handles and executes the menu selection at step 970, and then returns to step 910 to render the workspace 110 and await further user-input device events.

Thus, the above discussion demonstrates the applicability of discipline oriented and context-sensitive nature this present invention as it can be adapted to a statistics software application and learning tool. However, one of skill in the art would recognize that this system can be adapted to almost any other discipline. A brief discussion of other examples follows.

The present invention can further be adapted to the discipline of linear algebra. In this context, a user can check-in matrices, vectors, linear equations, system of equations, a vector space, linear transformations, constants, and other data-types for a linear algebra system. Each data set can be represented by an icon in the workspace, and preferably by an icon that meaningfully represents the particular data-type. The user can then interact with and select the input data sets. Depending on the specific set of user selected data sets, various user-operations can be presented to the user. For example, if two vectors are selected, the user can be presented with the operation of finding the scalar product of the two vectors. Furthermore, by selecting the two vectors, the user can explore the meaning of the scalar product of the vectors and how the operation is applied to the two selected vectors. If the user selects a single matrix, the software can generate a list of operations that can be performed on the selected matrix including: computing the inverse of the matrix; computing the transposer of the matrix; computing the characteristic polynomial of the matrix; computing the eigenvectors and/or eigenvalues of the matrix; computing the determinant of the matrix; and computing the diagonalization of the matrix. Each user-operation and selection of the iconic representation can include an explanation of the operation or data-type, and, with respect to data sets that resulted from a user-operation, the instructional explanation can include a description of how the result was calculated and its meaning.

Similarly, the present invention can be applied to a system for exploring and learning calculus. In the context of calculus, data sets can include functions, differential equations, and power series. The user-operations can include differentiation, indefinite and definite integrations, expansion of a function as a power series, graphing, calculation of the area between two curves, volumes of revolution, and composition of functions.

While the invention has so far been described with respect to highly mathematical and academic disciplines, it is not limited to such applications. Rather, the present invention can be adapted, for example, to include the disciplines of chemistry, geology, psychology, and medicine. One such example, which will now be described in more detail, includes investment and financial planning.

The present invention can provide non-expert investors with an environment that enables them to understand a variety of financial concepts as well as the tools to evaluate a number of possible investments and perform evaluation operations across one or more potential investments. The financial planning system can further focus on various types of investments rather than specific investment vehicles (e.g., asset classes rather than a particular stock).

A user can check-in various investments including stock shares, bonds, property, insurance, balanced mutual funds, and index funds. The check-in process can enable and display information regarding the asset class including a description and its characteristics. The user can further examine multiple scenarios by specifying initial investments and other optional events including recurring investment, withdrawals, dividends, etc. The software can further provide user-operations and tools to evaluate the expected values of investments of various periods of time. Furthermore, estimates of risk and possible outcome in case of poor performance can by further examined. Other tools include modification of assumptions, CPI calculations, and risk factor analysis. Selection of any checked-in data set enables the appropriate set of tools. Additionally, information units explaining the meaning of the tools are also enabled through selection of the particular data set. As a user becomes familiar with a basic set of tool through the discipline oriented explanations, the user can continue to explore more advanced tools and operations including options and derivative markets.

While the invention has been described in connection with a certain embodiment thereof, the invention is not limited to the described embodiments but rather is more broadly defined by the recitations in the claims below and equivalents thereof.

We claim:

1. A method for computer-based instruction concerning a discipline, the computer having a processor, a storage device, a user input device, and a display connected thereto, a plurality of information-units which are relevant to the discipline being stored in the storage device, and having an interactive, user-interface software executing on the processor, comprising the steps of:
accepting at user direction through the user-interface software at least one input data set having a data-type,
rendering any data sets containing data as iconic representations on the display,
enabling user-selectability of one or more of the iconic representations using the user input device,
dynamically establishing a selectable list of user-operations available through the user-interface software in response to any selection of the one or more iconic representations, and
enabling a particular one of the information units for user-selection through the user-interface software on the basis of a currently selected iconic representation, the particular information unit providing contextually-sensitive information regarding the currently selected iconic representation.

2. The method of claim 1, further comprising the step of generating additional iconic representations, before the step of enabling a particular one of the information units, the additional iconic representations being associated with a user-selected iconic representation based on any user-selected operation to be performed on the data set thereof.

3. The method of claim 1, wherein the iconic representation of each data set is determined by the data-type of the data set.

4. The method of claim 1, further comprising the step of incorporating the data contained in the selected data set into the contextually sensitive information.

5. The method of claim 1, further comprising the step of mapping the data-type of the data set to one or more contextual operations utilizing a rule base.

6. The method of claim 1, wherein the contextually-sensitive information includes help files.

7. The method of claim 1, wherein the contextually-sensitive information cross-references additional contextually-sensitive information.

8. The method of claim 1, wherein the list of user-operations includes at least one of tools, tests, and transformations.

9. The method of claim 1, further comprising the step of transforming one or more selected parent data sets into a derived data set.

10. The method of claim 9, wherein the derived data set includes an analysis of the selected parent data sets.

11. The method of claim 9, further comprising the step of graphically indicating a relationship between the parent data sets and the derived data set.

12. The method of claim 9, further comprising the step of displaying one or more contextually-sensitive informational units describing a relationship between the derived data set and the parent data set, in response to selection of the derived data set.

13. The method of claim 9, further comprising the step of displaying one or more contextually-sensitive informational units describing a discipline oriented explanation of the data in the derived data set.

14. The method of claim 1, further comprising the step of importing one or more input data sets from a database.

15. The method of claim 1, further comprising the step of determining the data-type of the input data set.

16. The method of claim 1, wherein the discipline is statistics and wherein the user-operations comprise user-selectable statistical analyses upon the accepted input data sets, and wherein the user interface is further configured to perform user-operations across multiple data sets.

17. A system for computer-based instruction concerning a discipline, comprising:
a computer having a processor, a storage device, and a display connected thereto;
a user input device interactively coupled with the computer;
a plurality of information-units which are relevant to the discipline and stored in the storage device; and
an interactive user interface software executing on the processor of the computer, the user interface software being configured to:
accept at user direction at least one input data set having a data-type,
render any data sets containing data as iconic representations on the display,
enable user-selectability of one or more of the iconic representations using the user input device,
dynamically establish a selectable list of user-operations in response to any selection of the one or more iconic representations, and
enable a particular one of the information units on the basis of a currently selected iconic representation, the particular information unit providing contextually-sensitive information regarding the currently selected iconic representation.

18. The system of claim 17, wherein the interactive user interface software is further configured to generate additional iconic representations, before enabling a particular one of the information units, the additional iconic representations being associated with a user-selected iconic representation based on any user-selected operation to be performed on the data set thereof.

19. The system of claim 17, wherein the iconic representation of each data set is determined by the data-type of the data set.

20. The system of claim 17, wherein the enabled contextually sensitive informational unit incorporates the data contained in the selected data set.

21. The system of claim 17, further comprising a rule base having a mapping of data-types to one or more contextual operations

22. The system of claim 17, wherein the relevant information units include help files.

23. The system of claim 17, wherein the relevant information units cross-references additional relevant information units.

24. The system of claim 17, wherein the list of user-operations includes at least one of tools, tests, and transformations.

25. The system of claim 17, wherein the user interface software is further configured to transform one or more selected parent data sets into a derived data set.

26. The system of claim 25, wherein the derived data set includes an analysis of the selected parent data sets.

27. The system of claim 25, wherein the user interface software is further configured to display graphically indicate a relationship between the parent data sets and the derived data set.

28. The system of claim 25, wherein the user interface software is further configured to display one or more relevant information units describing a relationship between the derived data set and the parent data set, in response to selection of the derived data set.

29. The system of claim 25, wherein the user interface software is further configured to display one or more relevant information units describing a discipline oriented explanation of the data in the derived data set.

30. The system of claim 17, wherein the one or more input data sets include data imported from a database.

31. The system of claim 17, wherein the user interface is further configure to determine the data-type of the input data set.

32. The system of claim 17, wherein the discipline is statistics and wherein the user-operations comprise user-selectable statistical analyses upon the accepted input data sets, and wherein the user interface is further configured to perform user-operations across multiple data sets.
